(19) United States
(12) Patent Application Publication
(10) Pub. No.: US 2008/0034054 A1
(43) Pub. Date: Feb. 7, 2008

(54) SYSTEM AND METHOD FOR RESERVATION FLOW CONTROL

(76) Inventors: Curtis Stehley, Baltimore, MD (US); Donald Pederson, San Diego, CA (US)

Correspondence Address: JAMES M. STOVER;TERADATA CORPORATION, 1700 SOUTH PATTERSON BLVD, WHQ5, DAYTON, OH, 45479, US

(21) Appl. No.: 11/462,779

(22) Filed: Aug. 7, 2006

(51) Int. Cl. G06F 15/167

(52) U.S. Cl. 709/213

(57) ABSTRACT

A technique for use in managing message passing between processors within a database system involves providing a plurality of message buffers on each of those processors that are configured to send or receive messages, the number of buffers on each processor being less than the number of processors. A reservation list is also provided on each of those processors that are configured to send or receive messages.

### BACKGROUND

Data organization is important in relational database systems that deal with complex queries against large volumes of data. Relational database systems allow data to be stored in tables that are organized as both a set of columns and a set of rows. Standard commands are used to define the columns and rows of tables and data is subsequently entered in accordance with the defined structure. The defined table structure is locally maintained, but may not correspond to the physical organization of the data. For example, the data corresponding to a particular table may be split up among several physical hardware storage facilities.

Users of relational database systems require the minimum time possible for execution of complex queries against large amounts of data. For the purposes of efficiency it is often necessary to redistribute rows from a large table among a set of physical hardware storage devices or to duplicate a large table on several storage facilities.

In a parallel shared nothing relational database system, the redistribution of rows from a large table requires many processing elements within the database system sending many monocast messages to a single destination processing element. Duplication of a large table within the same database system on all processing elements requires many processing elements sending many broadcast messages that need to be received by all processing elements. In both cases some sort of flow control mechanism is needed to prevent a receiver processor from being overwhelmed by too many messages. Otherwise in the event that a receiver processor is unable to keep up the memory of the processor would quickly be exhausted and it would crash.

Most message flow control schemes in use at present work by means of a window or a credit/debit counter. In these schemes a fixed amount of memory is allocated on the receiver processor for each sender processor, and the sender and receiver cooperate to manage that memory. A disadvantage of such schemes is that to achieve good performance a significant amount of memory needs to be allocated on the receiver for each sender. A further disadvantage is that the amount of memory required increases linearly with the number of senders.

An alternative flow control scheme in use is referred to in this specification as the wait and retry scheme. This scheme allocates a fixed number of buffers on the receiver regardless of the number of senders. These buffers are managed exclusively by the receiver. If no buffer is available to store a received message, a negative acknowledgement is sent back to the sender. The sender waits for a fixed time interval and then resends the message.

A disadvantage of the wait and retry scheme is that it wastes network bandwidth. There is an additional cost in discarding each message for which no buffer is available. Discarding messages consumes additional resources and leaves fewer resources on a processor available for substantive work.

### SUMMARY

Described below is a method of managing message passing between processors within a database system. The database system comprises a plurality of electronic storage devices having data stored thereon, a plurality of processors managing storage of the data on the electronic storage devices and a network connecting the processors.

One technique described below involves providing a plurality of message buffers on each of those processors that are configured to send or receive messages, the number of buffers on each processor being less than the number of processors. It will be appreciated that a virtual processor will have a plurality of buffers associated with that virtual processor rather than stored on the physical processor. A reservation list is provided on each of those processors that are configured to send or receive messages.

A message is transmitted from a sender processor to one or more destination processors over the network, the message including a message identifier. The buffers on the destination processor(s) are checked for an available buffer. If there is an available buffer at the time of receiving the message, the message is stored in the available buffer. Otherwise the message identifier of the message is stored in the reservation list.

In one form the technique further comprises the steps, if there is not an available buffer, of transmitting a negative acknowledgement message from the destination processor(s) to the sender processor, checking the buffers on the destination processor(s) for an available buffer, retrieving a message identifier from the reservation list on the destination processor(s) and transmitting an availability notification message to the sender of the message identified by the retrieved message identifier.

On the other hand if there is an available buffer, the method in one form further includes the step of transmitting a positive acknowledgement message from a destination processor(s) to the sender processor.

Described below is also a database management system that includes a plurality of electronic storage devices having data stored thereon, a plurality of processors managing storage of the data on the electronic storage devices, and a network connecting the processors, the network configured to pass messages between two or more of the processors. The messages are identified by respective message identifiers. The database system also includes a plurality of message buffers maintained on each of those processors that are configured to send or receive messages. Each buffer is configured to store a message received by the receiver processor from a sender processor, the number of buffers on each processor being less than the number of processors.

The database management system also includes a reservation list maintained on each of those processors that are configured to send or receive messages. The reservation list is configured to store the message identifier of a message received by a receiver processor if each buffer on the receiver processor already contains a message.

Described below is also a processor for use in a database management system that includes a plurality of buffers and a reservation list.

### BRIEF DESCRIPTION OF THE DRAWINGS

FIG. 1 is a block diagram of a node of a database system that includes processing modules.

FIG. 2 is a block diagram of the processing modules of FIG. 1 implementing a new reservation flow control system.

FIG. 3 is a block diagram of processing modules in a database system incorporating a prior art flow control system referred to in this specification as a window or credit/debit counter.

FIG. 4 is a block diagram of processing modules in a database system incorporating an alternative prior art flow control system referred to in this specification as a wait and retry scheme.

FIG. 5 is a flow diagram showing the new reservation flow control process.

### DETAILED DESCRIPTION OF DRAWINGS

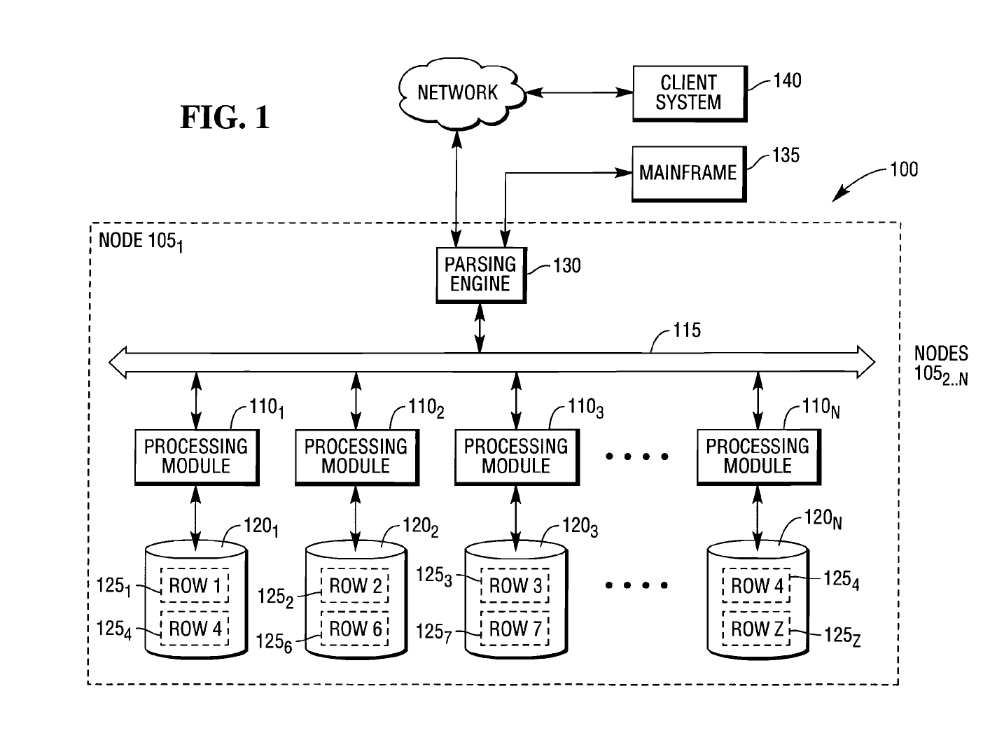

The reservation flow control technique described in this specification has particular application but is not limited to large databases that might contain many millions or billions of records managed by a database system (DBS) 100, such as a Teradata Active Data Warehousing System available from NCR Corporation. FIG. 1 shows a sample architecture for one node 105₁ of the DBS 100. The DBS node 105₁ includes one or more processing modules 110_{1 . . . N} connected by a network 115. The processing modules manage the storage and retrieval of data stored in data storage facilities 120_{1 . . . N}. Each of the processing modules in one form comprise one or more physical processors. In another form they comprise one or more virtual processors, with one or more virtual processors running on one or more physical processors.

Each of the processing modules 110_{1 . . . N} manages a portion of a database that is stored in corresponding data storage facilities 120_{1 . . . N}. Each of the data storage facilities 120_{1 . . . N} includes one or more disk drives. The DBS may include multiple nodes 105_{2 . . . N} in addition to the illustrated node 105₁, connected by extending the network 115.

The system stores data in one or more tables in the data storage facilities 120_{1 . . . N}. The rows 125_{1 . . . Z} of the tables are stored across multiple data storage facilities 120_{1 . . . N} to ensure that the system workload is distributed evenly across the processing modules 110_{1 . . . N}. A parsing engine 130 organizes the storage of data and the distribution of table rows 125_{1 . . . Z} among the processing modules 110_{1 . . . N}. The parsing engine 130 also coordinates the retrieval of data from the data storage facilities 120_{1 . . . N} in response to queries received from a user at a mainframe 135 or a client computer 140. The DBS 100 usually receives queries and commands to build tables in a standard format, such as SQL.

The rows 125_{1 . . . Z} are distributed across the data storage facilities 120_{1 . . . N} by the parsing engine 130 in accordance with a primary index. The primary index defines the columns of the rows that are used for calculating a hash value. The function that produces the hash value from the values in the columns specified by the primary index is called the hash function. Some portion, possibly the entirety, of the hash value is designated as a hash bucket. The hash buckets are assigned to data-storage facilities 120_{1 . . . N} and associated processing modules 110_{1 . . . N} by a hash bucket map. The characteristics of the columns chosen for the primary index determine how evenly the rows are distributed.

To aid efficiency it is often necessary to redistribute rows from a large table. To redistribute rows 3 and 7 from data storage facility 120₃ to data storage facility 120₁ requires a series of monocast messages between processing module 110₃ and processing 110₁. To duplicate a table on all processing elements on the other hand will require many broadcast messages from each of processing modules 110_{1 . . . N} to each other processing module 110_{1 . . . N}.

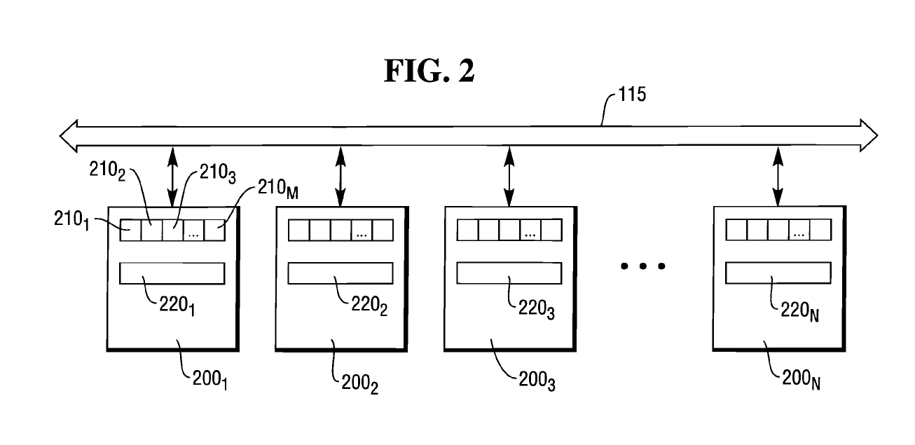

FIG. 2 shows a group of processing modules 200_{1 . . . N} equivalent to processing modules 110_{1 . . . N} shown in FIG. 1. Some or all of the processing modules 200_{1 . . . N} for example 200₁, have stored on or are at least associated with a plurality of buffers for example buffers 210_{1 . . . M}. The number of buffers associated with each processor 200 is fixed and does not vary dynamically. It will be envisaged that the number of buffers on a particular processing module could be manually altered. It is preferable but not essential that the same number of buffers are associated with each processor. Some processors for example have more memory or higher performance demands than others. Such processors will typically have greater and fewer buffers respectively associated with them.

The number of buffers, for example the value of M, is substantially less than the number of processing modules, for example the value of N. This means that M<N−1. There are substantially fewer buffers associated with each processor in the database system or node than there are total processing modules in the system or node. Some or all of the buffers 210_{1 . . . M} associated with each processing module 200_{1 . . . N} are configured to store respective messages transmitted over the network from a sender processing module to the destination processing module with which the buffers are associated. Each buffer is sized appropriately to store an individual message. The messages typically relate to the transfer of data between data storage devices interfaced to the processing modules 200_{1 . . . N}. The messages are stored in one of the buffers, if a buffer is available, until the processing module has the resources available to action the received message.

Some or all of the processing modules 200_{1 . . . N} include or have associated within them a reservation list 220_{1 . . . N}. Each message transferred over the network includes a message identifier sufficient to distinguish each message from other messages transferred over the network. In contrast to the buffers that require a fixed amount of memory, the reservation list requires a variable amount of memory. Where a buffer is not available to receive a new message, the message identifier of the message is stored in the reservation list 220 of the processing module that received the message.

In one implementation each message identifier requires 8 bytes and so only a modest amount of memory is required to hold a relatively large reservation list. For example a reservation list containing 1,024 message identifiers will require only 8,192 bytes of memory of the processing module.

The reservation list 220_{1 . . . N} is a first in first out (FIFO) queue. Message identifiers are stored in the order in which they are received by the processing module and the message identifier that has been stored in the reservation list the longest is retrieved first. It is envisaged that alternative configurations are available. A flow chart describing the use of these processing modules that include a fixed number of buffers and a reservation list will be described below.

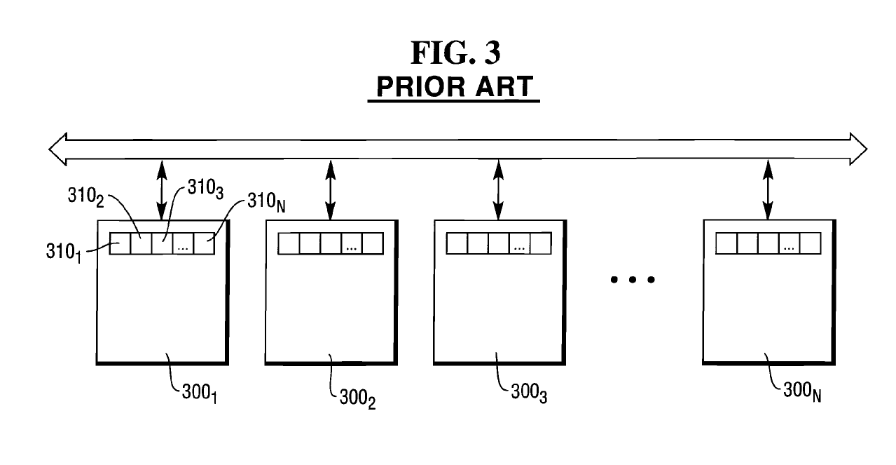

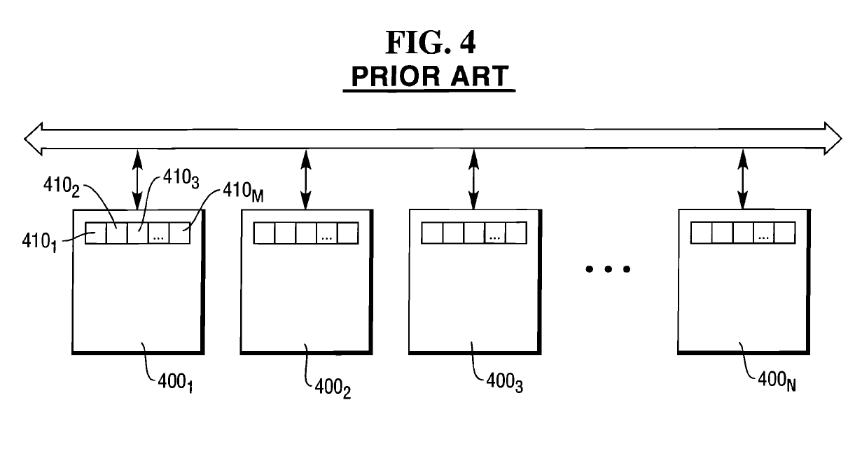

FIGS. 3 and 4 indicate two prior art processing module configurations for the purposes of comparison.

FIG. 3 shows a processing module configuration implementing a prior art window or credit/debit scheme. Some or all of the processing modules 300_{1 . . . N} have stored on or are at least associated with a plurality of buffers. Processing module 300, for example, has buffers 310_{1 . . . N}. A fixed amount of memory is allocated on each processor 300_{1 . . . N} in the system for each other processing module 300_{1 . . . N}. To achieve good performance with such a prior art scenario, a significant amount of memory needs to be allocated on each receiver processing module for each sender processing module. In a system that includes N processing modules, it is desirable to have at least N−1 or N buffers associated with each processor 300_{1 . . . N}. In a system or application that enables a processor to send messages to itself, N buffers would be required. In a system that does not permit a processor to send to itself, N−1 buffers would be required. Where virtual processors are mapped to a single physical processor, N buffers will generally be required. In the management of data in a large database system, there are many possible sender processing modules and allocating a significant amount of memory on each possible receiver processing module for each sender is problematic.

For example, if for each of 100 database jobs running concurrently there are 1000 senders sending to one receiver and if, for good performance, 100,000 bytes needs to be allocated on the receiver for each sender, then a total of 10 billion bytes needs to be allocated on the receiver. Such large amounts of memory are rarely available for message buffering.

FIG. 4 shows a processing module configuration implementing a wait and retry scheme. The wait and retry scheme does not require as much buffer memory for good performance as the window or credit/debit scheme from FIG. 3. In this scheme some or all of the processing modules 400_{1 . . . N} have stored on or are at least associated with a fixed number of buffers. For example processing module 400, is configured to act as a receiver and has associated buffers 410_{1 . . . M}. In this case the value of M representing the number of buffers associated with each processing module is less than the number of processing modules N in the database system or node. The number of buffers is fixed and may not necessarily be the same number associated with each processing module. The number of buffers on a particular processing module capable of receiving messages is determined regardless of the number of possible sender processing modules. The buffers are managed exclusively by the receiver processing module.

When a message is received the receiver checks to see if a buffer is available. If a buffer is available the message is stored in the buffer and a positive acknowledgement is sent back to the sender. If no buffer is available the received message is discarded and a negative acknowledgment is sent back to the sender. Upon receipt of a negative acknowledgement the sender waits for a fixed time interval and then resends the message.

One disadvantage of the wait and retry scheme is that it wastes network bandwidth. In fact, as the number of senders that are sending to one receiver increases, the amount of network bandwidth that will likely be wasted increases super linearly. Compared to the window and credit/debit schemes described above in FIG. 3, the wait and retry scheme has the advantage of constant and manageable memory usage but the disadvantage of super linear network bandwidth overhead.

There is an additional disadvantage associated with the wait and retry scheme. Discarding a message wastes resources in the form of interrupts, CPU cycles and I/O bus bandwidth. As a receiver starts to fall behind the rest of the system the number of messages that it needs to discard rapidly increases. Discarding those messages consumes additional resources and leaves fewer resources available for substantive work.

As a consequence of this, once a receiver falls behind it would tend to fall farther and farther behind. That receiver has the potential to become a “hot node”. A hot node is a processing element that for some period of time is slower and/or more heavily utilized than the other processing elements in the system. Since in most cases a parallel system is only as fast as its slowest processing element, a hot node will tend to have a negative impact on overall system performance.

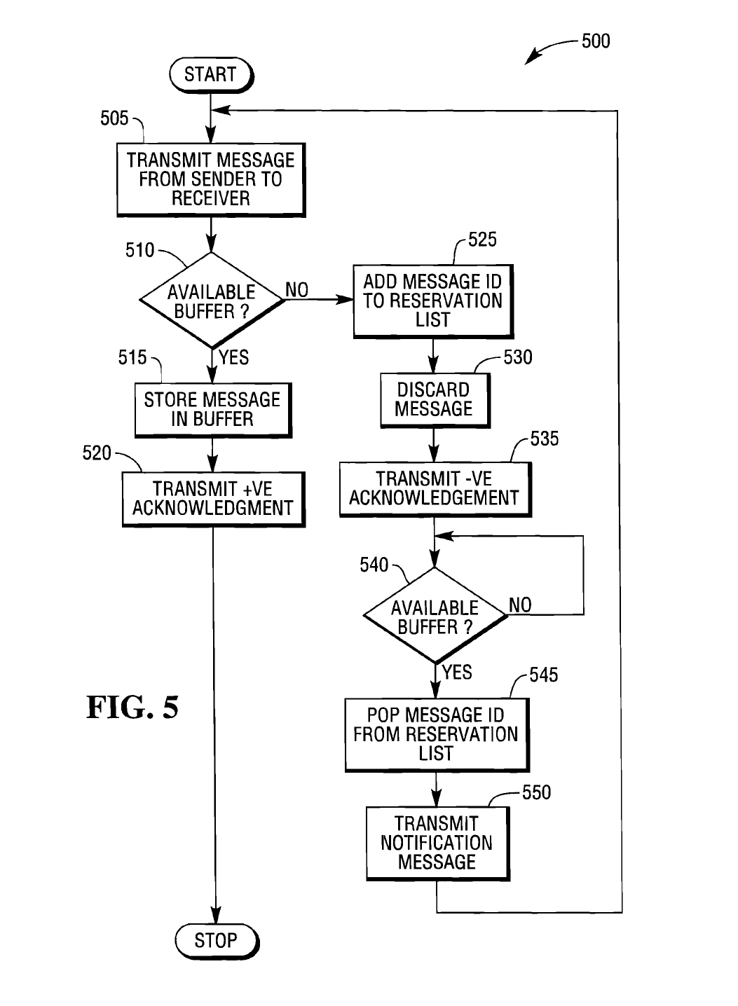

FIG. 5 illustrates a flow chart of a method of reservation flow control. This flow control scheme is designed to provide good performance particularly for redistributing and duplicating data in a parallel shared nothing relational database system. This technique typically requires only linear network bandwidth overhead and very nearly constant memory usage. Also, as a consequence of its linear network bandwidth overhead, the technique described below does not suffer from the “hot node” tendency associated with the wait and retry scheme.

Referring to FIG. 5, this technique 500 handles both monocast and broadcast messages. In a monocast message a message will be transmitted from a single sender processing module to a single destination processing module. In a broadcast message a single sender processing module will transmit messages to more than one destination processing module. In both cases a message is transmitted 505 from a sender processing module to one or more receiver processing modules.

When a message is received the receiver checks to see if one of a fixed number of buffers is available 510. If a buffer is available the message is accepted and stored 515 in an available buffer associated with the receiver. A positive acknowledgement is transmitted 520 from the receiver to the sender.

If a buffer is not available on receipt of a message, the receiver adds 525 the message identifier, for example a name or other identifier, to the reservation list of the receiver processing module. The message is discarded 530 and a negative acknowledgement is transmitted 535 from the receiver to the sender. A typical message includes a processor identifier of the sender.

The availability of a buffer is periodically checked 540 by the receiver. This checking is conducted by active notification in which the availability of a buffer generates a trigger or notifying event. For systems that do not include an active notification mechanism the checking is conducted by periodic polling of buffer availability. If a buffer becomes available, the next message ID is “popped” 545 from the reservation list of the receiver. By “popped” it is meant that the reservation list functions as a first in first out (FIFO) queue and that the next message ID, that is the message identifier that has been stored in the reservation list the longest, is removed from the reservation list.

The identity of the sender processing module is obtained from the message identifier. In one form the identity of the sender processing module forms part of the message identifier. In another form a simple hash table or other indexing structure is maintained that correlates a message identifier with a sender processing module. The receiver processing module transmits 550 a lightweight small availability notification message from the receiver to the sender informing the sender that the receiver is now prepared to receive the message as a buffer has become available.

Upon receipt of the notification message the sender resends or transmits the message. In one form a lock is placed on the available buffer so that the availability of the buffer is guaranteed for the resent message. In another form the resent message is treated just like any other transmitted message and on receipt of the resent message the receiver checks to see whether a buffer is still available.

With the reservation flow control described above, only a small number of network packets are needed per monocast message. In the best case two packets are required. These consist of one packet to send the message and a second packet to return a positive acknowledgement. In the worst case five packets are required. These consist of one packet to attempt to send the message the first time, a second packet to return a negative acknowledgement, a third packet to notify the sender that a buffer has become available, a fourth packet to resend the message and a fifth packet to return a positive acknowledgment.

As described above, this technique of reservation flow control works for both monocast and broadcast messages. Since a broadcast message is received by all receivers it can only be accepted once a buffer is available at every receiver. The sender needs to wait to receive a positive acknowledgment or a negative acknowledgement and a notification packet from each receiver in the system. Then the message can be committed or resent as necessary.

With reservation flow control only a small number of network packets are needed per broadcast message. In a system with N processing modules, in the best case a broadcast message transmission will require one broadcast packet plus N monocast packets. These consist of a broadcast packet to send a message, and N monocast packets returning positive acknowledgements. In the worst cast two broadcast messages plus 3×N monocast packets are required. These consist of one broadcast packet to attempt to send the message the first time, N monocast packets returning negative acknowledgements, N monocast packets returning reservation notifications, a broadcast packet to send the message the second time and N monocast packets returning positive acknowledgements. Since N monocast packets consume approximately the same amount of resources as one broadcast packet the broadcast result is essentially the same as the monocast. The best case scenario is two packets and the worst case is five packets.

The text above describes one or more specific embodiments of a broader invention. The invention also is carried out in a variety of alternative embodiments and thus is not limited to those described here. Those other embodiments are also within the scope of the following claims.

We claim:

1. A method of managing message passing between processors within a database system comprising a plurality of electronic storage devices having data stored thereon, a plurality of processors managing storage of the data on the electronic storage devices and a network connecting the processors, the method comprising:
transmitting a message from a sender processor to one or more destination processors over the network, the message including a message identifier;
checking one or more message buffers associated with the one or more destination processors for an available buffer, where the number of buffers associated with each processor is less than the number of processors; and
if there is an available buffer at the time of receiving the message, storing the message in the available buffer, otherwise storing the message identifier of the message in a reservation list associated with some or all of those processors configured to send or receive messages.

2. The method of claim 1 further comprising the steps, if there is not an available buffer, of:
transmitting a negative acknowledgement message from the destination processor(s) to the sender processor;
checking the buffers associated with the destination processor(s) for an available buffer;
retrieving a message identifier from the reservation list associated with the destination processor(s); and
transmitting an availability notification message to the sender of the message identified by the retrieved message identifier.

3. The method of claim 1 further comprising the step, if there is an available buffer, of transmitting a positive acknowledgement message from the destination processor(s) to the sender processor.

4. A database management system, comprising:
a plurality of electronic storage devices having data stored thereon;
a plurality of processors managing storage of the data on the electronic storage devices;
a network connecting the processors, the network configured to pass messages between two or more of the processors, the messages identified by respective message identifiers;
a plurality of message buffers associated with some or all of those processors configured to send or receive messages, some or all of the buffers configured to store respective messages received by the receiver processor from a sender processor, the number of buffers associated with each processor being less than the number of processors; and
a reservation list associated with some or all of those processors configured to send or receive messages, the reservation list configured to store the message identifier of a message received by a receiver processor if each buffer on the receiver processor already contains a message.

5. The database management system of claim 4, where the system is configured to:
transmit a message from a sender processor to one or more destination processors over the network;
check the buffers associated with the destination processor(s) for an available buffer; and
if there is an available buffer at the time of receiving the message, store the message in the available buffer, otherwise store the message identifier of the message in the reservation list.

6. The database management system of claim 5, where the system is configured, if there is not an available buffer, to:
transmit a negative acknowledgement message from the destination processor(s) to the sender processor;
check the buffers associated with the destination processor(s) for an available buffer;
retrieve a message identifier from the reservation list associated with the destination processor(s); and
transmit an availability notification message to the sender of the message identified by the retrieved message identifier.

7. The database management system of claim 5, where the system is configured, if there is an available buffer, to transmit a positive acknowledgement message from the destination processor(s) to the sender processor.

8. A receiver processor for managing the storage of data on an electronic storage device within a database management system having a plurality of sender processors and a network connecting the processors, the processor comprising a plurality of message buffers configured to send or receive messages between the receiver processor and one or more of the sender processors connected together by the network, some or all of the buffers configured to store a message received by the receiver processor from a sender processor, the number of buffers associated with the sender processor being less than the number of processors within the database management system; and
a reservation list associated with the receiver processor configured to send or receive messages, the reservation list configured to store the message identifier of a message received by a receiver processor if each buffer associated with the receiver processor already contains a message.

9. A system for managing message passing between processors within a database system comprising a plurality of electronic storage devices having data stored thereon, a plurality of processors managing storage of the data on the electronic storage devices and a network connecting the processors, where the system is configured to:
provide a plurality of buffers associated with some or all of those processors configured to send or receive messages, the number of buffers on each processor being less than the number of processors;
provide a reservation list associated with some or all of those processors configured to send or receive messages;
transmit a message from a sender processor to one or more destination processors over the network, the message including a message identifier;
check the buffers associated with the destination processor(s) for an available buffer; and
if there is an available buffer at the time of receiving the message, store the message in the available buffer, otherwise store the message identifier of the message in the reservation list.

10. A computer program stored on tangible storage media comprising executable instructions for performing a method of managing method passing between processors within a database system comprising a plurality of electronic storage devices having data stored thereon, a plurality of processors managing storage of the data on the electronic storage devices and a network connecting the processors, the method comprising the steps of:
providing a plurality of buffers associated with some or all of those processors configured to send or receive messages, the number of buffers on each processor being less than the number of processors;
providing a reservation list associated with some or all of those processors configured to send or receive messages;
transmitting a message from a sender processor to one or more destination processors over the network, the message including a message identifier;
checking the buffers associated with the destination processor(s) for an available buffer; and
if there is an available buffer at the time of receiving the message, storing the message in the available buffer, otherwise storing the message identifier of the message in the reservation list.
